(19) United States
(12) Patent Application Publication
(10) Pub. No.: US 2025/0198480 A1
(43) Pub. Date: Jun. 19, 2025

(54) DAMPING VALVE AND SHOCK ABSORBER

(71) Applicant: KYB Corporation, Tokyo (JP)

(72) Inventors: Akira NIGORISAWA, Tokyo (JP); Akihiro TSUCHIYA, Tokyo (JP); Isao KUROIWA, Tokyo (JP)

(73) Assignee: KYB Corporation, Tokyo (JP)

(21) Appl. No.: 18/845,725

(22) PCT Filed: May 24, 2023
(86) PCT No.: PCT/JP2023/019283

§ 371 Date: Sep. 10, 2024

(30) Foreign Application Priority Data
Jun. 23, 2022 (JP) 2022-101427

(51) Int. Cl. F16F 9/512; F16F 9/34

(52) U.S. Cl. CPC F16F 9/512; F16F 9/34

(57) ABSTRACT

A damping valve of the present invention includes: a valve seat member including an annular recess portion, a port that opens at a bottom portion of the recess portion, an annular valve seat that rises from an outer circumference of the recess portion, and a facing portion that is annular spacer and has an inner circumferential surface facing the recess portion; and a sub valve that is disposed in the recess portion and spaced apart from the bottom portion of the recess portion, is in an annular shape, forms an annular gap between the outer circumferential surface and the facing portion, and is allowed to be deflected in a direction away from the valve seat member in the recess portion with the outer circumference side as a free end; and a leaf valve that is in an annular shape, is stacked to be separated in an axial direction on a side of the sub valve opposite to the valve seat member, has an outer circumference side as a free end, is allowed to be deflected, and is able to be separated and seated on the valve seat.

### TECHNICAL FIELD

The present invention relates to a damping valve and a shock absorber.

### BACKGROUND ART

Conventionally, a damping valve is used, for example, to generate a damping force by offering resistance to a flow of liquid produced during extension and contraction of a shock absorber. In addition, as disclosed in JP 2019-183918 A, for example, such a damping valve includes an annular valve body having an inner circumference fixed to a piston rod and allowed to be deflected to both axial sides of an outer circumference, a cup-shaped valve case having an annular facing portion facing the outer circumference of the annular valve body and forming a gap for allowing passage of liquid, a spacer for supporting the inner circumference of the annular valve body, and a valve stopper for regulating the deflection of the annular valve seat.

According to the damping valve configured as described above, in a speed region where the extension/contraction speed (piston speed) of the shock absorber is low and the annular valve body is not deflected, the gap formed between the outer circumference of the annular valve body and the annular facing portion of the valve case is maintained in a narrow state. On the other hand, when the piston speed of the shock absorber is increased and the outer circumference side of the annular valve body is deflected, the outer circumference end of the annular valve body is separated from the annular facing portion, so that the gap is widened.

Therefore, the shock absorber using the damping valve described above to generate the damping force can increase the damping coefficient in a very low-speed range where the extension/contraction speed is lower than the low speed to quickly raise the damping force in proportional to the extension/contraction speed, and make the damping coefficient smaller than that in the very low-speed range in the low-speed range, thus making it possible to achieve the damping force characteristics suitable for improving the ride quality of a vehicle.

### CITATION LIST

### Patent Literature

Patent Literature 1: JP 2019-183918 A

### SUMMARY OF INVENTION

### Technical Problem

A damping valve of the related art is used to generate a damping force during extension and contraction of the shock absorber in a very low-speed range, and is installed in series with a leaf valve that generates a damping force during the extension and contraction at an extension/contraction speed equal to or higher than a low speed.

Specifically, the damping valve is stacked on a piston that partitions the inside of a cylinder in the shock absorber into an extension side chamber and a compression side chamber together with a stacked leaf valve that opens and closes a port provided in the piston, and is placed in the outer circumference of the piston rod.

Therefore, such a damping valve is stacked on the piston and the leaf valve and installed in the shock absorber, and the total length of a piston portion including the piston, the leaf valve, and the damping valve becomes long, so that there is a problem that a stroke length in the shock absorber becomes short.

In addition, in order to manufacture shock absorbers having different cylinder diameters, it is necessary to prepare a plurality of valve cases corresponding to the cylinder diameters, which is troublesome to manage components and increases manufacturing cost.

Furthermore, since the damping valve includes many parts such as a spacer and a valve stopper in addition to the annular valve body and the valve case, assemblability of the damping valve is poor and it takes time and effort to assemble the damping valve.

Therefore, an object of the present invention is to provide a damping valve and a shock absorber that can shorten the overall length, are inexpensive, and have good assemblability.

### Solution to Problem

In order to solve the above problems, a damping valve of the present invention includes: a valve seat member including an annular recess portion, a port that opens at a bottom portion of the recess portion, an annular valve seat that rises from an outer circumference of the recess portion, and a facing portion that is in an annular shape and has an inner circumferential surface facing the recess portion; a sub valve that is disposed in the recess portion to be separated from the bottom portion of the recess portion, is in an annular shape, forms an annular gap between the outer circumferential surface and the facing portion, and is allowed to be deflected in a direction separated from the valve seat member in the recess portion with an outer circumference side as a free end; and a leaf valve that is in an annular shape, is stacked to be separated in an axial direction on a side of the sub valve opposite to the valve seat member, is allowed to be deflected with an outer circumference side as a free end, and is able to be separated and seated on the valve seat.

In the damping valve configured as described above, the valve seat member including the valve seat on which the leaf valve is separated and seated is provided with the recess portion that accommodates the sub valve and allows the deflection of the sub valve and the facing portion facing the outer circumference of the sub valve, so that the valve seat member can function as both the valve seat of the sub valve and the valve seat of the leaf valve. As described above, according to the damping valve, the valve seats of both the sub valve and the leaf valve can be integrated into one valve seat member, the number of parts is reduced, and the overall length is shortened.

### BRIEF DESCRIPTION OF DRAWINGS

FIG. 1 is a longitudinal sectional view of a shock absorber including a damping valve according to one embodiment of the present invention.

FIG. 2 is a cross-sectional view of the damping valve according to the one embodiment of the present invention.

FIG. 3 is an enlarged view of a portion of the damping valve according to the one embodiment of the present invention.

FIG. 4 is a graph illustrating damping force characteristics of the shock absorber including the damping valve according to the one embodiment of the present invention.

FIG. 5 is a cross-sectional view of the damping valve according to a first modification of the one embodiment of the present invention.

FIG. 6 is a cross-sectional view of the damping valve according to a second modification of the one embodiment of the present invention.

### DESCRIPTION OF EMBODIMENTS

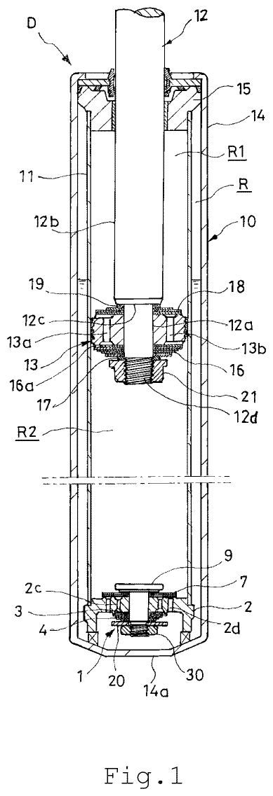

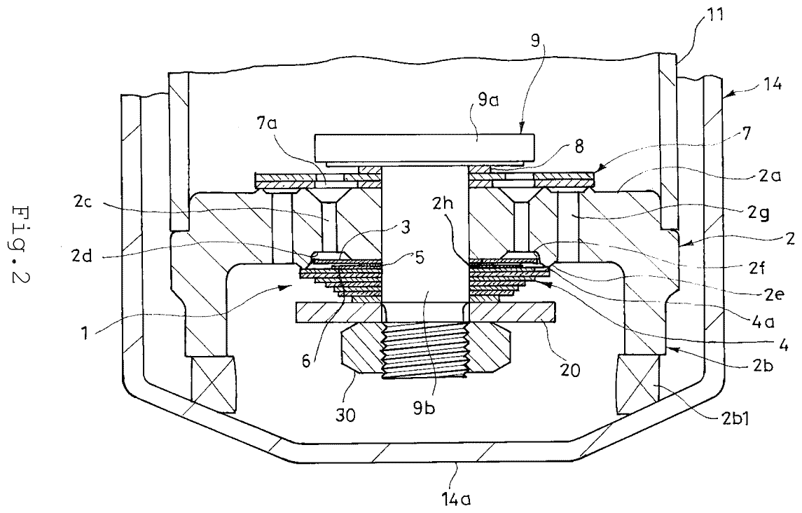

Hereinafter, the present invention will be described based on an embodiment illustrated in the drawings. As illustrated in FIGS. 1 and 2, a damping valve 1 of the present embodiment includes a valve case 2 as a valve seat member, a sub valve 3, and a leaf valve 4, is provided in a shock absorber main body 10 that includes an outer shell 14 and a rod 12 movably inserted into the outer shell 14 and is stretchable, and is used as a base valve of a shock absorber D. The shock absorber D is used by being interposed between a vehicle body and an axle in a non-illustrated vehicle in order to suppress vibrations of the vehicle body and a wheel.

Hereinafter, some components in the damping valve 1 and the shock absorber D will be described in detail. As illustrated in FIG. 1, the shock absorber main body 10 includes a cylinder 11, the bottomed cylindrical outer shell 14 that covers the outer circumference of the cylinder 11, the rod 12 that is inside the outer shell 14 and is movably inserted into the cylinder 11, and a piston 13 that is movably inserted into the cylinder 11 by being connected to the rod 12 and partitions the inside of the cylinder 11 into an extension side chamber R1 and a compression side chamber R2 used as the operation chambers.

A bracket (not illustrated) is provided at a base end that is an upper end, in FIG. 1, of the rod 12, and the rod 12 is connected to one of the vehicle body and the axle via the non-illustrated bracket. A bracket (not illustrated) is also provided on a bottom portion 14a of the outer shell 14, and the outer shell 14 is connected to the other of the vehicle body and the axle via the non-illustrated bracket.

The shock absorber main body 10 in the shock absorber D is interposed between the vehicle body and the axle in this manner. When the vehicle travels on a bumpy road, for example, and the wheel vibrates up and down relative to the vehicle body, the rod 12 enters and exits the outer shell 14, and the piston 13 moves up and down (axially) inside the cylinder 11.

In addition, the shock absorber main body 10 includes an annular rod guide 15 that closes the upper end of the cylinder 11 and the outer shell 14 and through the inner circumference of which the rod 12 is slidably inserted. This configuration makes the interior of the cylinder 11 and the outer shell 14 a sealed space.

Furthermore, the valve case 2 as a valve seat member is fitted to a lower end of the cylinder 11. The upper end of the outer shell 14 in FIG. 1 is swaged from the outer circumference side and deflected inward, and sandwiches the rod guide 15, the cylinder 11, and the valve case 2 accommodated in the outer shell 14 together with the bottom portion 14a.

The valve case 2 partitions the compression side chamber R2 in the cylinder 11 and a reservoir R formed by an annular gap between the cylinder 11 and the outer shell 14. The extension side chamber R1 and the compression side chamber R2 in the cylinder 11 are filled with liquid, and the reservoir R is filled with gas and liquid. Note that examples of the liquid filled in the shock absorber main body 10 may include operating fluid, water, an aqueous solution, other liquids, and the like.

When the shock absorber D extends, the rod 12 exits the cylinder 11 and the inner volume of the cylinder increases due to the volume of the rod 12 that has exited, the liquid is supplied from the reservoir R into the cylinder 11. On the contrary, when the shock absorber D contracts, the rod 12 enters the cylinder 11 and the inner volume of the cylinder decreases due to the volume of the rod 12 that has entered, the liquid is discharged from the cylinder 11 to the reservoir R.

As described above, the shock absorber D of the present embodiment is configured as a single-rod or a double cylinder type shock absorber, and performs volume compensation of the rod 12 entering and exiting the cylinder 11 by supplying and discharging liquid from the reservoir R into and from the cylinder 11.

The rod 12 includes a small-diameter portion 12a provided on the tip end side thereof, a step portion 12c provided at the boundary between the small-diameter portion 12a and a large-diameter portion 12b on the upper side in FIG. 1 with respect to the small-diameter portion 12a, and a screw portion 12d provided on the outer circumference of the tip of the small-diameter portion 12a.

Furthermore, the piston 13 is in an annular shape, is fitted to the outer circumference of the small-diameter portion 12a of the rod 12, is fixed to the rod 12 by a piston nut 21 screwed to the screw portion 12d of the rod 12, and can move in the vertical direction in FIG. 1, which is the axial direction, in the cylinder 11 together with the rod 12. More specifically, the piston 13 includes an extension side port 13a and a compression side port 13b that are in sliding contact with the inner circumference of the cylinder 11 to partition the inside of the cylinder 11 into an extension side chamber R1 on the upper side and a compression side chamber R2 on the lower side in FIG. 1, and communicate the extension side chamber R1 and the compression side chamber R2.

On the lower surface of the piston 13 in FIG. 1, an extension-side damping valve 16 which is an annular stacked leaf valve whose inner circumference side is fixed to the small-diameter portion 12a of the rod 12 to allow deflection on the outer circumference side and which opens and closes the extension side port 13a, and an annular spacer 17 which sets a position of a fulcrum of deflection of the extension-side damping valve 16 are overlapped.

In addition, on the upper surface of the piston 13 in FIG. 1, a compression-side check valve 18 which is in an annular shape, has an inner circumference side fixed to the small-diameter portion 12a of the rod 12 to allow deflection on the outer circumference side and which opens and closes the compression side port 13b, and an annular spacer 19 which sets a position of a fulcrum of deflection of the compression-side check valve 18 are overlapped.

The spacer 19, the compression-side check valve 18, the piston 13, the extension-side damping valve 16, and the spacer 17 are sequentially assembled to the outer circumference of the small-diameter portion 12a of the rod 12, and then sandwiched between the piston nut 21 screwed to the screw portion 12d at the tip end of the rod 12 and the step portion 12c of the rod 12 and fixed to the rod 12.

The extension-side damping valve 16 is a stacked leaf valve formed by stacking a plurality of annular plates, and has an inner circumference fixed to the rod 12 as described above and stacked at the lower end of the piston 13 in FIG. 1 to open and close the outlet end of the extension side port 13a of the piston 13, and an outer circumference including a notch orifice 16a that constantly communicates the extension side port 13a with the compression side chamber R2. Therefore, the extension-side damping valve 16 causes the extension side port 13a to communicate with the compression side chamber R2 only through the notch orifice 16a in a state where the opening end of the extension side port 13a is closed.

In the extension-side damping valve 16, when the extension side port side surface is the front surface, the pressure in the extension side chamber R1 acting on the front surface side via the extension side port 13a becomes higher than the pressure in the compression side chamber R2 acting on the back surface side, and when a difference between the pressures reaches a valve opening pressure, the outer circumference is deflected to open, and the extension side port 13a is opened. When the extension-side damping valve 16 is deflected to separate the outer circumference from the piston 13, an annular gap is formed between the extension-side damping valve and the piston 13, and the extension side port 13a communicates with the compression side chamber R2 through the gap to give resistance to the flow of liquid passing through the extension side port 13a. In the shock absorber D according to the present embodiment, the extension-side damping valve 16 opens when the extension speed of the shock absorber D is in the high-speed range, and offers resistance to the flow of the liquid from the extension side chamber R1 to the compression side chamber R2 through the extension side port 13a.

On the other hand, the compression-side check valve 18 is configured by stacking a plurality of annular plates, has the inner circumference fixed to the rod 12 as described above, is stacked on the upper end, in FIG. 1, of the piston 13, and opens and closes the outlet end of the compression side port 13b of the piston 13. Then, when the pressure in the compression side chamber R2 is higher than the pressure in the extension side chamber R1 and the difference between the pressures reaches the valve opening pressure, the compression-side check valve 18 deflects the outer circumference to open the compression side port 13b. The compression-side check valve 18 opens to open the compression side port 13b when the outer circumference is deflected to be separated from the piston 13, and allows the flow of liquid passing through the compression side port 13b from the compression side chamber R2 toward the extension side chamber R1. The valve opening pressure of the compression-side check valve 18 is set to be very low, and the compression-side check valve 18 is set so as not to give much resistance to the flow of liquid passing through the compression side port 13b when the valve is opened.

Note that the extension-side damping valve 16 is configured by stacking a plurality of annular plates, and the number of annular plates to be stacked can be changed depending on the damping force to be intended to occur in the shock absorber D as appropriate, and they may be formed as only one annular plate. In addition, the compression-side check valve 18 is also configured by stacking a plurality of annular plates, and the number of annular plates to be stacked can be changed as appropriate, and they may be formed as only one annular plate. In addition, the extension-side damping valve 16 and the compression-side check valve 18 may be valves other than the valve formed of annular plates, and by using a valve using a thin annular plate, it is possible to enjoy an advantage that the overall length of the piston portion of the shock absorber D is not increased and the stroke length of the shock absorber D is easily secured.

In addition, the inner circumferences of the extension-side damping valve 16 and the compression-side check valve 18 are supported by the spacer 17, 19, respectively, and deflection on the outer circumference side that is not supported by the spacer 17, 19 is allowed. Thus, setting the outer diameter of the spacer 17, 19, makes it possible to change the positions of the fulcrums of the deflection of the extension-side damping valve 16 and the compression-side check valve 18. Note that the spacer 17, 19 may include a plurality of annular washers.

Subsequently, the damping valve 1 includes a valve case 2 as a valve seat member, a sub valve 3, and a leaf valve 4. The valve case 2 has an annular shape and includes a base portion 2a fitted to the lower end of the cylinder 11 in FIG. 2 and a cylindrical portion 2b suspended from the outer circumference of the lower end of the base portion 2a.

The base portion 2a of the valve case 2 is provided with a compression-side damping port 2c as a plurality of ports penetrating the base portion 2a in the vertical direction, an annular recess portion 2d provided at the lower end of the base portion 2a in FIG. 2 and continuous with the opening end of the compression-side damping port 2c, an annular valve seat 2e rising from the outer circumference of the recess portion 2d at the lower end of the base portion 2a in FIG. 2, a facing portion 2f having an inner circumferential surface that is annular spacer and faces the recess portion 2d, and a plurality of suction ports 2g penetrating the base portion 2a in the vertical direction and disposed on the outer circumference side of the compression-side damping port 2c of the base portion 2a.

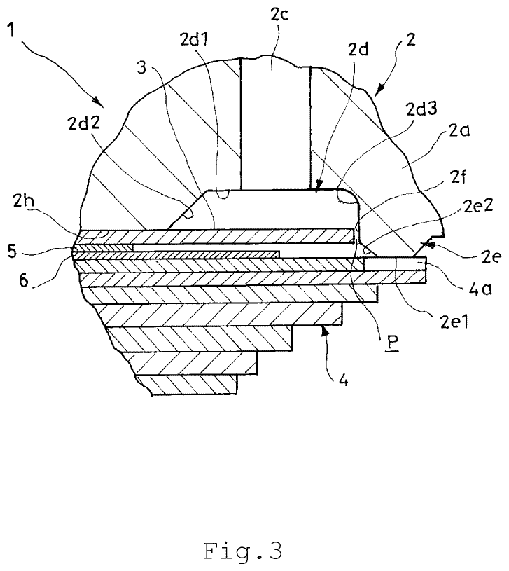

The plurality of compression-side damping ports 2c as ports are provided at equal intervals along the same circumference with respect to the base portion 2a, and vertically penetrate the base portion 2a to communicate the compression side chamber R2 with the space in the cylindrical portion 2b. The recess portion 2d has an annular shape and communicates with the opening end at the lower end of the compression-side damping port 2c in FIG. 2. As illustrated in FIG. 3, the recess portion 2d is formed of an annular bottom portion 2d1 in which the compression-side damping port 2c is opened, an annular tapered inner wall 2d2 serving as a wall portion on the inner circumference side of the bottom portion, and an annular outer wall 2d3 serving as a wall portion on the outer circumference side of the bottom portion and having a circumferential surface perpendicular to the base portion 2a, and has a shape in which the opening area increases as it goes downward in FIG. 3. An inner circumferential seat surface 2h having an annular shape and flat surface is provided at the lower end of the base portion 2a in FIG. 2 and on the inner circumference of the recess portion 2d.

As illustrated in FIG. 3, the valve seat 2e is provided so as to protrude downward in FIG. 2 from the outer circumference of the recess portion 2d at the lower end of the base portion 2a, and includes an annular seat surface 2e1 on which the leaf valve 4 is separated and seated, and an inclined surface 2e2 connected to the outer circumference of the recess portion 2d, and surrounds the outer circumference of the compression-side damping port 2c. Since the seat surface 2e1 of the valve seat 2e protrudes downward from the lower end of the base portion 2a, it is disposed below the inner circumferential seat surface 2h on the inner circumference side of the recess portion 2d in FIG. 2. Therefore, when viewed from the base portion 2a, the seat surface 2e1 is higher than the inner circumferential seat surface 2h, and there is a height difference between the two. In addition, since the bottom portion 2d1 forming the recess portion 2d is disposed above the inner circumferential seat surface 2h in FIG. 2, the bottom portion 2d1 is lower than the inner circumferential seat surface 2h when viewed from the base portion 2a, and there is a height difference between the two.

In the damping valve 1 of the present embodiment, the facing portion 2f is formed of the outer wall 2d3 that forms the recess portion 2d in the base portion 2a and has an inner circumferential surface facing the recess portion 2d.

The plurality of suction ports 2g are provided at equal intervals along the same circumference with respect to the base portion 2a, and vertically penetrate the base portion 2a to communicate the compression side chamber R2 with the space in the cylindrical portion 2b.

In the valve case 2, the base portion 2a is fitted to the inner circumference of the lower end of the cylinder 11 in FIG. 2, and the lower end of the cylindrical portion 2b comes into contact with the bottom portion 14a of the outer shell 14. The valve case 2 is sandwiched between the cylinder 11 and the bottom portion 14a of the outer shell 14 to partition the compression side chamber R2 in the cylinder 11 and the reservoir R between the cylinder 11 and the outer shell 14. A plurality of notches 2b1 are provided at a lower end of the cylindrical portion 2b of the valve case 2, and a space in the cylindrical portion 2b of the valve case 2 communicates with the reservoir R via the notches 2b1. Further, the space in the cylindrical portion 2b of the valve case 2 and the compression side chamber R2 communicate with each other through the compression-side damping port 2c and the suction port 2g. In this manner, the compression side chamber R2 and the reservoir R communicate with each other through the compression-side damping port 2c and the suction port 2g.

In the damping valve 1 of the present embodiment, the sub valve 3 is a single annular plate, has an inner diameter equal to the inner diameter of the base portion 2a and an outer diameter smaller than the diameter of the inner circumferential surface of the facing portion 2f formed of the outer wall 2d3 of the recess portion 2d, and overlaps the inner circumferential seat surface 2h provided at the lower end of the base portion 2a in the valve case 2. On the side opposite to the valve seat member of the sub valve 3, a spacer 5 having an inner diameter equal to the inner diameter of the sub valve 3 and an outer diameter smaller than the outer diameter of the sub valve 3, a valve stopper 6 having an inner diameter equal to the inner diameter of the sub valve 3 and an outer diameter smaller than the outer diameter of the sub valve 3 and larger than the outer diameter of the spacer 5, a leaf valve 4 separated and seated on the seat surface 2e1 of the valve seat 2e, and an annular regulating member 20 that regulates further deflection of the leaf valve 4 when the leaf valve 4 comes into contact with are sequentially stacked. In the above description, the sub valve 3 is configured of a single annular plate, but the number of annular plates constituting the sub valve 3 can be changed, and when the sub valve 3 is configured of a plurality of annular plates, the outer diameters of the annular plates may be different from each other.

On the compression side chamber side of the base portion 2a of the valve case 2, an annular suction check valve 7 that opens and closes an opening end of the suction port 2g, which is an upper end in FIG. 2, and a spacer 8 are overlapped with each other. The suction check valve 7 is formed by overlapping a plurality of annular plates, and includes a through hole 7a penetrating the annular plates vertically. Therefore, even if the suction check valve 7 comes into contact with the base portion 2a, the compression-side damping port 2c always communicates with the compression side chamber R2 via the through hole 7a, and the suction check valve 7 does not close the compression-side damping port 2c.

A shaft portion 9b of a guide rod 9 as a shaft member having a head portion 9a and a shaft portion 9b is inserted into the inner circumference of the spacer 8, the suction check valve 7, the base portion 2a of the valve case 2, the sub valve 3, the spacer 5, the valve stopper 6, the leaf valve 4, and the regulating member 20, and the spacer 8, the suction check valve 7, the base portion 2a of the valve case 2, the sub valve 3, the spacer 5, the valve stopper 6, the leaf valve 4, and the regulating member 20 are sandwiched by the head portion 9a and a nut 30 screwed to the tip end of the shaft portion 9b.

The inner circumference of the sub valve 3 is sandwiched and fixed by the spacer 5 and the inner circumferential seat surface 2h of the base portion 2a, and the outer circumference is a free end, and deflection of the outer circumference is allowed. A height difference is provided between the inner circumferential seat surface 2h of the base portion 2a and the bottom portion 2d1 forming the recess portion 2d, and there is a height difference between the inner circumferential seat surface 2h of the base portion 2a and the seat surface 2e1 on which the leaf valve 4 is separated and seated. The spacer 5 and the valve stopper 6 are provided between the leaf valve 4 and the sub valve 3, and a gap that allows deflection of the outer circumference of the sub valve 3 is formed between the sub valve 3 and the leaf valve 4. The sub valve 3 is stacked on the spacer 5 to be disposed away from the bottom portion 2d1 in the recess portion 2d, and is allowed to be deflected downward in FIG. 3, which is a direction away from the valve case 2, without closing the compression-side damping port 2c as a port.

The spacer 5 has an outer diameter smaller than the outer diameter of the sub valve 3, and forms a fulcrum of the deflection of the sub valve 3 in a direction away from the valve case 2 at an outer edge of an end surface facing the sub valve 3. Therefore, the sub valve 3 can deflect the outer circumference side downward in FIG. 2 with the outer edge of the spacer 5 as a fulcrum. The fulcrum of the deflection of the sub valve 3 can be tuned by setting the outer diameter of the spacer 5, and the deflection amount until the sub valve 3 comes into contact with the valve stopper 6 can be tuned by changing the number of stacked layers and the thickness of the spacer 5.

The sub valve 3 can deflect the outer circumference side upward in FIG. 2 with the outer edge of the inner circumferential seat surface 2h has a fulcrum. A sufficient height difference between the bottom portion 2d1 of the recess portion 2d and the inner circumferential seat surface 2h is provided so as not to block the compression-side damping port 2c even when the sub valve 3 is deflected upward in FIG. 2.

In the initial attachment state illustrated in FIG. 3, in the sub valve 3, the outer circumferential surface faces the inner circumferential surface of the annular facing portion 2f, and thus it faces the facing portion 2f with a predetermined annular gap P therebetween. Furthermore, in the damping valve 1 according to the present embodiment, the annular gap P formed between the sub valve 3 and the facing portion 2f has a very narrow width and has an opening area smaller than that of the notch orifice 4a provided in the leaf valve 4 described below.

The valve stopper 6 is formed of an annular plate having an outer diameter larger than the outer diameter of the spacer 5 and smaller than the outer diameter of the sub valve 3, and having elasticity. Therefore, when the outer circumference of the sub valve 3 is deflected downward in FIG. 2 and comes into contact with the valve stopper 6, the valve stopper 6 comes into contact with the non-valve seat member side of the sub valve 3 to support the sub valve 3 and regulate the deflection of the sub valve 3.

The leaf valve 4 is a stacked leaf valve formed by stacking a plurality of annular plates, and has the inner circumference of which is fixed to the valve case 2 by the guide rod 9 as described above, and the outer circumference of which is seated on the seat surface 2e1 of the valve seat 2e provided in the valve case 2. Among the annular plates constituting the leaf valve 4, the annular plate stacked on the uppermost side in FIG. 2 and seated on the valve seat 2e has an outer diameter larger than the outer diameter of the sub valve 3, and includes the notch orifice 4a on the outer circumference. Thus, in a state of being seated on the valve seat 2e, the leaf valve 4 communicates between the compression-side damping port 2c surrounded by the valve seat 2e and the reservoir R through only the notch orifice 4a.

In a case where the surface on the valve seat member side corresponding to the valve case side of the leaf valve 4 is the front surface, when the differential pressure between the pressure in the compression side chamber R2 acting on the front surface side via the compression-side damping port 2c and the pressure in the reservoir R acting on the back surface side reaches the valve opening pressure, the leaf valve 4 deflects the outer circumference and separates from the valve seat 2e. When separated from the valve seat 2e, the leaf valve 4 forms an annular gap with the valve seat 2e, communicates between the compression-side damping port 2c and the reservoir R through the gap, and offers resistance to the flow of the liquid passing through the compression-side damping port 2c. In the damping valve 1 according to the present embodiment, the leaf valve 4 opens when the contraction speed of the shock absorber D is in the high-speed range, which offers the resistance against the flow of liquid passing through the compression-side damping port 2c from the compression side chamber R2 to the reservoir R. In addition, the leaf valve 4 is set in a one-way passage that allows only the flow of the liquid flowing through the compression-side damping port 2c from the compression side chamber R2 to the reservoir R.

In addition, the valve seat 2e protrudes downward in FIG. 2 from the lower end in FIG. 2, which is the end on the side opposite to the valve seat of the valve stopper 6 with which the inner circumference of the leaf valve 4 comes into contact, and there is a difference in height (height difference) between the two. When the leaf valve 4 is overlapped on the valve case 2 together with the sub valve 3, the spacer 5, and the valve stopper 6 and the inner circumference side is fixed to the outer circumference of the shaft portion 9b of the guide rod 9, the outer circumference is deflected by the height difference. In this way, the leaf valve 4 is given an initial deflection in advance and presses itself against the valve seat 2e with the elastic force exerted by the leaf valve 4 itself. Thus, the leaf valve 4 does not open until the force for deflecting the leaf valve 4 due to the differential pressure between the compression side chamber R2 and the reservoir R overcomes the pressing force due to the resilient force described above, and the differential pressure at the time of valve opening is the valve opening pressure of the leaf valve 4. Therefore, the valve opening pressure of the leaf valve 4 can be adjusted by the deflection stiffness of the leaf valve 4 and the initial deflection amount given to the leaf valve 4.

Note that the leaf valve 4 is configured by stacking a plurality of annular plates, and the number of annular plates to be stacked can be changed depending on the damping force to be intended to occur in the shock absorber D as appropriate, and they may be formed as only one annular plate. Instead of or in addition to providing the notch orifice 4a in the leaf valve 4, a recess portion functioning as an orifice may be provided by stamping the valve seat 2e.

The suction check valve 7 has an inner circumference fixed to the guide rod 9 together with the spacer 8 as described above, is stacked on the upper end of the base portion 2a of the valve case 2 in FIG. 2, and opens and closes the outlet end of the suction port 2g provided in the valve case 2. The spacer 8 is in an annular shape, and has an inner diameter set to be the same as the inner diameter of the suction check valve 7 and an outer diameter set to be a diameter that does not block the through hole 7a of the suction check valve 7. Therefore, the suction check valve 7 is allowed to be deflected upward in FIG. 2 on the outer circumference side with the outer edge of the valve seat member side end of the spacer 8 as a fulcrum.

When the pressure in the reservoir R is higher than the pressure in the compression side chamber R2 and the difference between the pressures of the two reaches the valve opening pressure, the suction check valve 7 deflects the outer circumference to open the valve and opens the suction port 2g. The suction check valve 7 opens to open the suction port 2g when the outer circumference is deflected to be separated from the valve case 2, and allows the flow of liquid passing through the suction port 2g from the reservoir R toward the compression side chamber R2. The valve opening pressure of the suction check valve 7 is set to be very low, and the suction check valve 7 is set so as not to give much resistance to the flow of liquid passing through the suction port 2g when the valve is opened. The suction check valve 7 is configured by stacking a plurality of annular plates, and the number of annular plates to be stacked can be changed as appropriate, and they may be formed as only one annular plate. In addition, a notch orifice may be provided in the suction check valve 7, or a recess portion functioning as an orifice may be provided in the valve seat on which the suction check valve 7 is separated and seated.

The damping valve 1 and the shock absorber D of the present embodiment are configured as described above. Hereinafter, an operation of the damping valve 1 and the shock absorber D will be described. First, a case where the shock absorber D performs an extension operation will be described. In the extension operation of the shock absorber D in which the rod 12 moves upward with respect to the cylinder 11 and the outer shell 14 in FIG. 1, the piston 13 moves upward with respect to the cylinder 11 in FIG. 1 to compress the extension side chamber R1 and expand the compression side chamber R2. When the extension speed of the shock absorber D is low, the difference between the pressure in the extension side chamber R1 to be compressed and the pressure in the expanding compression side chamber R2 does not reach the valve opening pressure of the extension-side damping valve 16, so that the liquid in the extension side chamber R1 passes through the extension side port 13a and the notch orifice 16a and moves to the compression side chamber R2. In the enlarged compression side chamber R2, the rod 12 exits from the cylinder 11, so that the liquid corresponding to the volume of the rod 12 exiting from the cylinder 11 is insufficient. However, the suction check valve 7 is opened, and the insufficient liquid is supplied from the reservoir R into the compression side chamber R2 through the suction port 2g. During the extension operation of the shock absorber D, since the suction check valve 7 quickly opens to open the suction port 2g in this manner, the liquid that tries to move from the reservoir R to the compression side chamber R2 passes through the suction port 2g without passing through the notch orifice 4a, the annular gap P between the sub valve 3 and the facing portion 2f, and the compression-side damping port 2c.

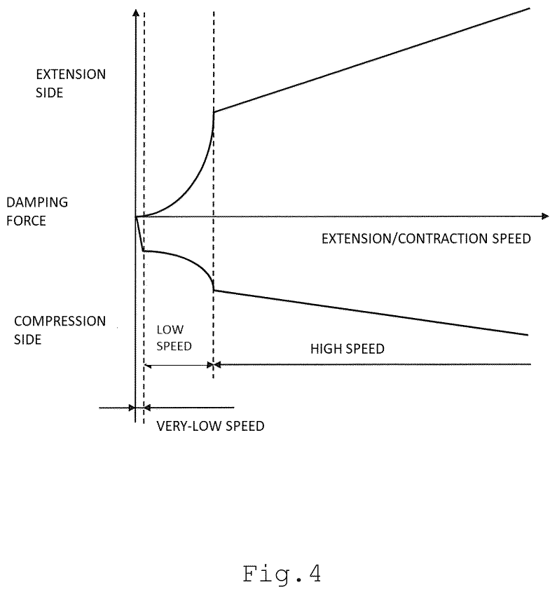

As described above, when the extension speed of the shock absorber D is low, the shock absorber D applies resistance to the flow of liquid passing through the extension side port 13a by the notch orifice 16a to generate a damping force that hinders the extension operation of the shock absorber D. Therefore, when the shock absorber D extends at a low speed, the damping force characteristics on the extension side, which is the characteristic of the damping force generated by the shock absorber D with respect to the piston speed, is a characteristic proportional to the square of the piston speed peculiar to the orifice, as illustrated in FIG. 4.

When the extension speed of the shock absorber D increases, the difference between the pressure in the compressed extension side chamber R1 and the pressure in the expanding compression side chamber R2 reaches the valve opening pressure of the extension-side damping valve 16, and the extension-side damping valve 16 opens to open the extension side port 13a. As described above, when the extension speed of the shock absorber D is high, the shock absorber D applies resistance to the flow of liquid passing through the extension side port 13a by the extension-side damping valve 16 to generate a damping force that hinders the extension operation of the shock absorber D. Therefore, as illustrated in FIG. 4, the damping force characteristics on the extension side when the shock absorber D extends at a high speed is lower than that when the damping coefficient is at a low speed, and becomes a characteristic specific to the leaf valve proportional to the piston speed.

Next, a case where the shock absorber D performs the contraction operation will be described. In the contraction operation of the shock absorber D in which the rod 12 moves downward with respect to the cylinder 11 and the outer shell 14 in FIG. 1, the piston 13 moves upward with respect to the cylinder 11 in FIG. 1 to compress the compression side chamber R2 and expand the extension side chamber R1. By the contraction operation of the shock absorber D, the liquid in the compression side chamber R2 to be compressed moves to the extension side chamber R1 expanding through the compression side port 13b without receiving much resistance by the opening of the compression-side check valve 18. In addition, at the time of the contraction operation of the shock absorber D, since the rod 12 enters the cylinder 11, the liquid corresponding to the volume of the rod 12 entering the cylinder 11 becomes excessive in the cylinder 11, and the pressure in the cylinder 11 increases. Since the pressure in the compression side chamber R2 becomes higher than the pressure in the reservoir R, the suction check valve 7 is closed to close the suction port 2g. Therefore, the excess liquid moves from the compression side chamber R2 to the reservoir R via the compression-side damping port 2c. When the contraction speed of the shock absorber D is low, the difference between the pressure in the compression side chamber R2 to be compressed and the pressure in the reservoir R does not reach the valve opening pressure of the leaf valve 4, so that the liquid in the compression side chamber R2 moves to the reservoir R through the compression-side damping port 2c, the annular gap P between the sub valve 3 and the facing portion 2f, and the notch orifice 4a.

The sub valve 3 in the damping valve 1 is deflected when the rod 12 starts to move in the contraction direction with respect to the cylinder 11, and the deflection amount of the sub valve 3 increases as the contraction speed of the shock absorber D increases. Furthermore, in a case where the contraction speed of the shock absorber D approaches 0 (zero) such as when the contraction begins, the deflection amount of the sub valve 3 is very small. The sub valve 3 is deflected to the extent that it fails to face the inner circumferential surface of the facing portion 2f between the very low-speed range and the low-speed range, and then the sub valve 3 opens. Further, in the case where the contraction speed of the shock absorber D becomes the low-speed or the high-speed, the outer circumference portion of the sub valve 3 is deflected significantly downward in FIG. 3 with the outer circumferential edge of the spacer 5 used as fulcrum of the deflection. In a case where the differential pressure between the pressure in the compression side chamber R2 and the pressure in the reservoir R when the sub valve 3 is deflected and opened separately from the facing portion 2f, that is, the valve opening pressure of the sub valve 3 is lower than the valve opening pressure of the leaf valve 4, and the contraction speed is in the low speed range, the sub valve 3 opens as described above, but the leaf valve 4 does not open, and the liquid moves from the compression side chamber R2 to the reservoir R via the annular gap P and the notch orifice 4a.

If the annular gap P becomes substantially zero in a state where the sub valve 3 faces the inner circumferential surface of the facing portion 2f, a differential pressure is generated between the compression side chamber R2 and the reservoir R immediately after the shock absorber D starts to move, so that the shock absorber D can quickly generate a damping force when the shock absorber D is switched from the extension operation to the contraction operation.

As described above, when the contraction speed of the shock absorber D is low and high, the outer circumference portion of the sub valve 3 is greatly deflected downward in FIG. 3, and the opening area of the annular gap P formed between the sub valve 3 shifted downward and the facing portion 2f is larger than the opening area of the notch orifice 4a.

Accordingly, when the contraction speed of the shock absorber D is in the very low-speed range and is close to zero, the pressure in the compression side chamber R2 rises, but the differential pressure between the pressure in the compression side chamber R2 and the pressure in the reservoir R does not reach the valve opening pressure of the leaf valve 4, and thus, the leaf valve 4 does not open and the compression-side damping port 2c remains closed. In addition, since the differential pressure does not reach the valve opening pressure of the sub valve 3, even if the sub valve 3 is deflected, its outer circumferential surface faces the range of the axial width of the inner circumference of the facing portion 2f, resulting in the valve closing state. This maintains a flow path area of the annular gap P between the sub valve 3 and the facing portion 2f to be extremely small. The liquid passes through the compression-side damping port 2c, the annular gap P, and the notch orifice 4a and moves from the compression side chamber R2 to the reservoir R. However, since the flow path area of the annular gap P in the sub valve 3 in the valve closed state is smaller than the flow path area of the notch orifice 4a, when the contraction speed of the shock absorber D is in a very low-speed range, the shock absorber D generates a damping force that prevents contraction mainly by the resistance applied to the liquid by the sub valve 3. Thus, in the case where the contraction speed of the shock absorber D is in the very low-speed range, the damping force characteristics on the compression side of the shock absorber D are such that the damping coefficient rises very large at the contraction speed near zero and then decreases at the opening of the sub valve 3, as illustrated in FIG. 4. As described above, by generating the damping force by the sub valve 3 when the shock absorber D contracts at a very low-speed, a damping force sufficient to suppress vibration at the beginning of extension and contraction of the shock absorber D can be obtained, and the ride quality in the vehicle can be improved.

Therefore, when the contraction speed of the shock absorber D is the low speed, the shock absorber D generates a damping force that interferes with the contraction mainly due to the resistance offered to the liquid by the notch orifice 4a. Thus, when the contraction speed of the shock absorber D is the low speed, the damping force characteristics on the compression side of the shock absorber D are such that the damping force is proportional to the square of the contraction speed of the shock absorber D, as is peculiar to the orifice and as illustrated in FIG. 4, but the damping coefficient becomes smaller than when the contraction speed is in the very low-speed range.

Besides, during the increase in the contraction speed of the shock absorber D changing from the very low-speed range to the low-speed range, the differential pressure between the pressure in the reservoir R and the pressure in the compression side chamber R2 exceeds the valve opening pressure of the sub valve 3. Thus, the sub valve 3 is deflected so that its outer circumference deviates upward in FIG. 3 from the range of the axial width of the inner circumference of the facing portion 2f, and the sub valve 3 is open, which increases the flow path area of the annular gap P between the sub valve 3 and the facing portion 2f more than the flow path area of the notch orifice 4a. When the sub valve 3 is deflected and cannot face the facing portion 2f, the outer circumference of the sub valve 3 faces the valve seat 2e. Since the inclined surface 2e2 is provided on the inner circumference of the valve seat 2e, the flow path area between the sub valve 3 and the valve case 2 rapidly increases when the sub valve 3 is deflected, and the sub valve 3 can be prevented from affecting the damping force when the shock absorber D contracts at a low speed.

The sub valve 3 is deflected and comes into contact with the valve stopper 6 and the leaf valve 4 to be supported by the valve stopper 6 and the leaf valve 4. Since the sub valve 3 is supported in an arcuately deflected state at two places that come into contact with the valve stopper 6 and the leaf valve 4 in the radial direction, the valve stopper 6 is regulated from being deformed to undulate with a width from the inner circumference to the outer circumference. When the sub valve 3 is deformed so as to undulate, a large stress acts on the sub valve 3 to promote fatigue. However, the valve stopper 6 and the leaf valve 4 support two positions on the back surface of the sub valve 3 to prevent the deformation, so that the fatigue of the sub valve 3 can be reduced.

Besides, when the contraction speed of the shock absorber D goes beyond the low-speed range and falls in the high-speed range, the differential pressure between the pressure in the compression side chamber R2 and the pressure in reservoir R reaches the differential pressure that is the valve opening pressure of the leaf valve 4, and the leaf valve 4 is deflected and opens, which causes the compression-side damping port 2c to be opened. In the case where the contraction speed of the shock absorber D is the high speed, the difference between the pressure in the compression side chamber R2 and the pressure in the reservoir R exceeds the valve opening pressure of the sub valve 3. Thus, the sub valve 3 is open, which makes the flow path area of the annular gap P between the sub valve 3 and the facing portion 2f large. The sub valve 3 is deflected together with the valve stopper 6 and the leaf valve 4 while coming into contact with the valve stopper 6 and the leaf valve 4. Therefore, it is possible to prevent the sub valve 3 from narrowing the flow path area of the compression-side damping port 2c in a state where the leaf valve 4 is opened to open the compression-side damping port 2c. In the case where the contraction speed of the shock absorber D is the high speed, the sub valve 3 is deflected significantly, and the flow path area in the gap between the leaf valve 4 and the valve seat 2e becomes smaller than that in the annular gap P. Thus, when the contraction speed of the shock absorber D is the high speed, the shock absorber D generates a damping force that interferes with the contraction mainly due to the resistance offered to the liquid by the leaf valve 4. Therefore, when the contraction speed of the shock absorber D is the high speed, the damping force characteristics on the compression side of the shock absorber D are such that the damping force is proportional to the contraction speed of the shock absorber D, as is peculiar to the leaf valve 4 and as illustrated in FIG. 4, but the damping coefficient becomes further smaller than when the contraction speed is the low speed.

As described above, since the sub valve 3 is installed between the outlet end of the compression-side damping port 2c as a port and the leaf valve 4, the sub valve 3 in the damping valve 1 generates a damping force only when the shock absorber D performs the contraction operation.

The damping valve 1 and the shock absorber D according to the present embodiment operate as described above. The damping valve 1 of the present embodiment includes: a valve case (valve seat member) 2 including an annular recess portion 2d, a compression-side damping port (port) 2c that opens at a bottom portion 2d1 of the recess portion 2d, an annular valve seat 2e that rises from an outer circumference of the recess portion 2d, and a facing portion 2f that is annular spacer and has an inner circumferential surface facing the recess portion 2d; and a sub valve 3 that is disposed in the recess portion 2d and spaced apart from the bottom portion 2d1 of the recess portion 2d, is in an annular shape, forms an annular gap P between the outer circumferential surface and the facing portion 2f, and is allowed to be deflected in a direction away from the valve case (valve seat member) 2 in the recess portion 2d with the outer circumference side as a free end; and, a leaf valve 4 that is in an annular shape, is stacked to be separated in an axial direction on a side of the sub valve 3 opposite to the valve seat member, has an outer circumference side as a free end, is allowed to be deflected, and is able to be separated and seated on the valve seat 2e.

In the damping valve 1 configured as described above, the valve case (valve seat member) 2 including the valve seat 2e on which the leaf valve 4 is separated and seated is provided with the recess portion 2d that accommodates the sub valve 3 and allows the deflection of the sub valve 3 and the facing portion 2f facing the outer circumference of the sub valve 3, so that the valve case (valve seat member) 2 can function as the valve seats of both the sub valve 3 and the leaf valve 4.

Therefore, in the damping valve of the related art, a valve case, a piston, and the like each including a valve seat are provided for each of the sub valve and the leaf valve. However, in the damping valve 1 of the present embodiment, the valve seats of both the sub valve 3 and the leaf valve 4 can be integrated into one valve case (valve seat member) 2, the number of parts is reduced, and the overall length is shortened. In addition, according to the damping valve 1, the valve seats of both the sub valve 3 and the leaf valve 4 can be integrated into one valve case (valve seat member) 2, and the number of parts can be reduced, so that assemblability can be improved. Furthermore, according to the damping valve 1, even in the case of manufacturing the shock absorber D having different diameters of the cylinders 11, only the valve case (valve seat member) 2 needs to correspond to the diameter of the cylinder 11. Therefore, as compared with the damping valve in the related art, the number of components can be reduced, so that the components can be easily managed, and the manufacturing cost can be reduced. As described above, according to the damping valve 1 of the present embodiment, the total length can be shortened, and the assemblability can be improved at low cost.

In addition, in the damping valve 1 of the present embodiment, since the sub valve 3 is installed between the outlet end of the compression-side damping port (port) 2c and the leaf valve 4 and includes the suction port 2g that allows only the flow of liquid in the direction opposite to the compression-side damping port (port) 2c, the sub valve 3 in the damping valve 1 can generate the damping force only during contraction operation of the shock absorber D by the sub valve 3. As described above, since the sub valve 3 can be set as a unidirectional valve that generates the damping force only by one of the extension operation and the contraction operation of the shock absorber D, the damping force at the time of the extension operation and the damping force at the time of the contraction operation of the shock absorber D can be independently set.

The damping valve 1 of the present embodiment may be applied to a piston portion of the shock absorber D. Therefore, for example, similarly to the valve case (valve seat member) 2, if the piston 13 described above is provided with a recess portion connected to the outlet end of the extension side port 13a, a valve seat that surrounds the outer circumference of the recess portion and on which the extension-side damping valve 16 is separated and seated, and a facing portion facing the recess portion, and the sub valve 3 that is allowed to be deflected on the outer circumference side in the recess portion is installed between the extension-side damping valve 16 and the piston 13, the damping force can be generated by the sub valve 3 when the shock absorber D is extended at a very-low speed during the extension operation.

As described above, when the damping valve 1 is applied to the piston portion and a base valve portion in the shock absorber D set to the double cylinder type, it is possible to exert a damping force sufficient to suppress the vibration at the beginning of the extension and contraction of the shock absorber D by the sub valve 3 both during the extension operation and the contraction operation of the shock absorber D. In addition, the sub valve 3 incorporated in the valve case 2 of the base valve portion does not affect the damping force at the time of the extension operation of the shock absorber D, and the sub valve 3 incorporated in the piston 13 of the piston portion does not affect the damping force at the time of the contraction operation of the shock absorber D. Therefore, the damping force at the time of the extension operation and the damping force at the time of the contraction operation of the shock absorber D set to the double cylinder type can be independently set. In addition, the damping valve 1 of the present embodiment is applied to the base valve of the shock absorber D, and may be applied only to the piston portion. In this way, even if the damping valve 1 is applied only to the piston portion, the total length of the piston portion is shortened, the effect of reducing the number of parts is exhibited, and the assemblability can be improved at low cost.

As described above, the shock absorber D includes the shock absorber main body 10 that has the cylindrical outer shell 14 and the rod 12 movably inserted into the outer shell 14 and is extendable and contractible, and the damping valve 1, and the valve case (valve seat member) 2 partitions the compression side chamber (operation chamber) R2 and the reservoir (operation chamber) R communicated with each other by the compression-side damping port (port) 2c in the shock absorber main body 10. According to the shock absorber D configured as described above, since the total length of the damping valve 1 can be shortened, it is easy to secure the stroke length, and the number of parts of the damping valve 1 is reduced, so that the assemblability is also improved.

Note that a shock absorber set to be a monotube using an outer shell forming an outer shell of the shock absorber D as a cylinder does not include a base valve, and includes a damping valve only in a piston portion. More specifically, in a monotube shock absorber, a piston connected to a rod is movably inserted into an inner circumference of an outer shell, an extension side chamber and a compression side chamber partitions in the outer shell by the piston are communicated by an extension side port and a compression side port similarly provided in the piston, a compression-side leaf valve that opens and closes the compression side port is provided on the extension side chamber side of the piston, an extension-side leaf valve that opens and closes the extension side port is provided on the compression side chamber side of the piston, and a free piston that partitions a gas chamber facing the compression side chamber is movably inserted into the outer shell in order to compensate for a volume of the rod entering and exiting the outer shell. The structure of the damping valve 1 can be applied to the piston portion of the monotube shock absorber by providing a recess portion in the piston of the monotube shock absorber and installing the sub valve between the leaf valve and the piston. In the monotube shock absorber, when the structure of the damping valve 1 is applied to the piston portion, the sub valve can be installed between the leaf valve on the extension side and the piston and/or between the leaf valve on the compression side and the piston. In addition, in such a monotube shock absorber, when the sub valve is provided at least one of between the extension-side leaf valve and the piston and between the compression-side leaf valve and the piston, the sub valve can allow both the flow of liquid, through a port, from the extension side chamber to the compression side chamber and the flow of liquid from the compression side chamber to the extension side chamber and the flow of liquid from the compression side chamber to the extension side chamber, and can deflect the outer circumference to both the piston side and the leaf valve side. Therefore, when an orifice is formed in the extension-side leaf valve or the compression-side leaf valve provided with the sub valve, the sub valve can function as a valve that generates damping force at both the time of extension operation and the time of contraction operation of the shock absorber. Even if the structure of the damping valve 1 is applied to the monotube shock absorber in this manner, since one piston functions as a valve seat member for both the sub valve and the leaf valve, the total length of the piston portion can be shortened, and the stroke length of the shock absorber can be easily secured.

Further, the valve case (valve seat member) 2 in the damping valve 1 of the present embodiment includes an inclined surface 2e2 between the facing portion 2f and the seat surface 2e1 on which the leaf valve 4 of the valve seat 2e is separated and seated. As described above, since the valve case (valve seat member) 2 includes the inclined surface 2e2, when the sub valve 3 is deflected, the flow path area of the gap between the outer circumference of the sub valve 3 and the valve case (valve seat member) 2 quickly increases, and the sub valve 3 can be prevented from affecting the damping force when the shock absorber D contracts at a low speed.

In addition, when the valve case (valve seat member) 2 is manufactured by sintering, by providing the inclined surface 2e2 between the seat surface 2e1 of the valve seat 2e and the facing portion 2f formed by a cylindrical surface perpendicular to the seat surface 2e1, a corner portion having a fragile cross section at a right angle is not formed between the facing portion 2f and the seat surface 2e1. Therefore, according to the damping valve 1 of the present embodiment, durability of the valve seat (valve seat member) 2 can be improved. When the valve case (valve seat member) 2 is manufactured by sintering, the durability of the valve seat (valve seat member) 2 is improved by providing the inclined surface 2e2 between the facing portion 2f and the seat surface 2e1. Therefore, according to the damping valve 1, the facing portion 2f can be disposed close to the seat surface 2e1 of the valve seat 2e in the radial direction, and the degree of freedom in designing the inner diameter of the facing portion 2f and the outer diameter of the sub valve 3 can be improved. In the present embodiment, the inclined surface 2e2 is a tapered surface having a constant gradient in the cross section, but may be a curved surface or an inclined surface whose gradient changes stepwise.

In addition, the damping valve 1 of the present embodiment includes the valve stopper 6 that is disposed between the sub valve 3 and the leaf valve 4 to be separated from the sub valve 3, is in an annular shape, allows to be deflected on the outer circumference side, and regulates deflection of the sub valve 3 when the outer circumference of the sub valve 3 is deflected in a direction away from the valve case (valve seat member) 2 and comes into contact with the valve case 2. According to the damping valve 1 configured as described above, when the sub valve 3 is deflected in a direction away from the valve case (valve seat member) 2 while coming into contact with the valve stopper 6, the sub valve 3 is supported by the leaf valve 4 in addition to the valve stopper 6, so that it is possible to suppress the undulation deformation of the sub valve 3 and reduce the fatigue of the sub valve 3.

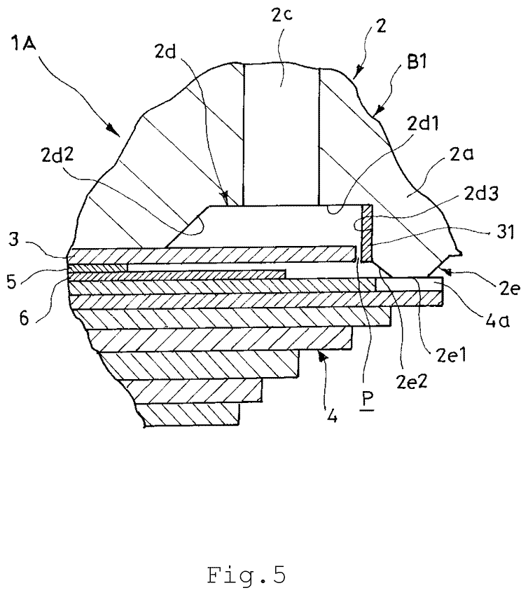

In the above description, the outer wall 2d3 itself on the outer circumference side of the recess portion 2d of the valve case 2 as the valve seat member is a facing portion 2f facing the outer circumferential surface of the sub valve 3 and forming the annular gap P with the outer circumference of the sub valve 3. However, as in a damping valve 1A of the first modification illustrated in FIG. 5, the valve case 2 may include a valve seat member main body B1 including the recess portion 2d, a valve seat 2e, and a compression-side damping port 2c as a port, and a ring 31 forming the facing portion 2f on the inner circumference of the outer wall 2d3 on the outer circumference of the recess portion 2d in the valve seat member main body B1.

The ring 31 has a circular annular shape, has an inner diameter larger than the outer diameter of the sub valve 3, is press-fitted into the inner circumference of the outer wall 2d3 of the recess portion 2d, and is fixed in the recess portion 2d. As described above, the valve case 2 includes the ring 31, and the inner circumferential surface of the ring 31 is a facing portion facing the outer circumferential surface of the sub valve 3. The height of the ring 31 in the axial direction is set to be equal to or less than the depth of the recess portion 2d, so that the ring 31 does not protrude from the recess portion 2d in the axial direction.

The sub valve 3, the spacer 5, the valve stopper 6, and the leaf valve 4 are stacked on the inner circumferential seat surface 2h of the valve case 2, and the guide rod 9 and the nut 30 fix the inner circumferences of the sub valve 3, the spacer 5, the valve stopper 6, and the leaf valve 4 to the outer circumference of the shaft portion 9b of the guide rod 9. As described above, the damping valve 1A in the first modification is different from the damping valve 1 described above in that the valve case (valve seat member) 2 includes the ring 31 placed in the outer wall 2d3 of the recess portion 2d, and the inner circumferential surface of the ring 31 is a facing portion.

The damping valve 1A in the first modification configured as described above operates similarly to the damping valve 1, and generates a damping force by the sub valve 3 during the contraction operation of the shock absorber D at a very-low speed. According to the damping valve 1A in the first modification, since the valve case (valve seat member) 2 includes the ring 31 functioning as the valve seat of the sub valve 3 and includes the valve seat 2e of the leaf valve 4, similarly to the damping valve 1, the total length can be shortened, the number of parts can be reduced, and the assemblability can be improved. In addition, when the valve seat member main body B1, which is a portion other than the ring 31 of the valve case (valve seat member) 2, is manufactured by sintering, the ring 31 having high dimensional accuracy of the inner diameter can be placed in the outer wall 2d3 of the recess portion 2d. Therefore, according to the damping valve 1A, it is easy to manage the dimension of the annular gap P between the sub valve 3 and the ring 31, and it is easy to realize the intended damping force characteristics. Even if the valve case (valve seat member) 2 is configured by the valve seat member main body B1 and the ring 31, the ring 31 may be fitted and placed in the recess portion 2d, so that the valve case (valve seat member) 2 can be manufactured and the assemblability can be improved.

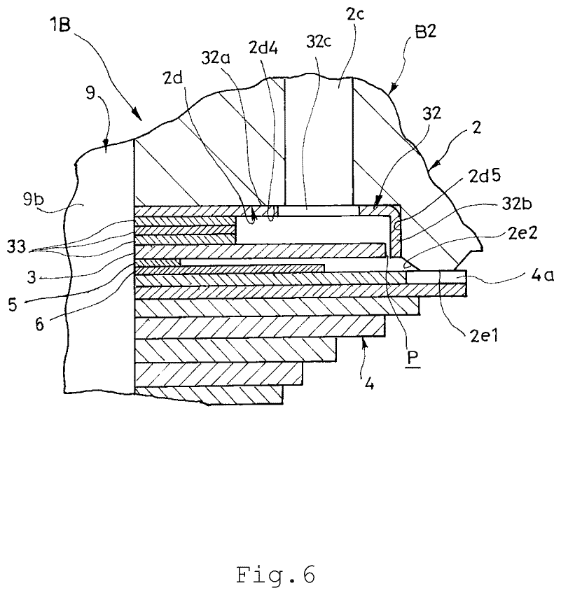

In addition, as in a damping valve 1B of the second modification illustrated in FIG. 6, a cup 32 may be accommodated in the recess portion 2d instead of the ring 31, and the cup 32 may be used as a facing portion. Specifically, the valve case (valve seat member) 2 includes a valve seat member main body B2 having a recess portion 2d and the cup 32.

The valve seat member main body B2 includes a base portion 2a and a cylindrical portion 2b suspended from the outer circumference of the lower end of the base portion 2a. The base portion 2a is provided with a compression-side damping port 2c as a plurality of ports penetrating the base portion 2a in the vertical direction, an annular recess portion 2d provided at the lower end of the base portion 2a in FIG. 6 and continuous with the opening end of the compression-side damping port 2c, an annular valve seat 2e rising from the outer circumference of the recess portion 2d at the lower end of the base portion 2a in FIG. 6, a facing portion 2f having an inner circumferential surface that is annular spacer and faces the recess portion 2d, and a plurality of suction ports 2g penetrating the base portion 2a in the vertical direction and disposed on the outer circumference side of the compression-side damping port 2c of the base portion 2a.

The recess portion 2d has an annular shape and communicates with the opening end at the lower end of the compression-side damping port 2c in FIG. 6. As illustrated in FIG. 6, the recess portion 2d is formed of an annular bottom portion 2d4 in which the compression-side damping port 2c is opened, and an annular outer wall 2d5 serving as a wall portion on the outer circumference side of the bottom portion 2d4 and having a circumferential surface perpendicular to the base portion 2a. The valve case 2 of the damping valve 1B is different from the damping valve 1 in that the bottom portion 2d4 of the recess portion 2d is extended to the inner circumference of the base portion 2a.

The cup 32 has a bottomed cylindrical shape and includes a circular annular bottom portion 32a, a cylindrical portion 32b rising from the outer circumference of the bottom portion 32a, and a plurality of circular arc-shaped holes 32c provided in the bottom portion 32a. The inner diameter of the bottom portion 32a is the same as the inner diameter of the base portion 2a, and when the cup 32 is inserted into the recess portion 2d and the bottom portion 32a is placed on the bottom portion 2d4 of the recess portion 2d, each compression-side damping port 2c faces any hole 32c, and the compression-side damping port 2c is not blocked by the cup 32. In addition, the height of the cup 32 in the axial direction is set to be equal to or less than the depth of the recess portion 2d so that the cylindrical portion 32b of the cup 32 does not protrude from the recess portion 2d in the axial direction.

The spacer 33, the sub valve 3, the spacer 5, the valve stopper 6, and the leaf valve 4, which are annular spacer and have a smaller diameter than the sub valve 3, are sequentially stacked on the bottom portion 32a of the cup 32 accommodated in the recess portion 2d in the valve seat member main body B2. The valve seat member main body B2, the cup 32, the spacer 33, the sub valve 3, the spacer 5, the valve stopper 6, and the leaf valve 4 are sandwiched by the guide rod 9 and the nut 30 inserted in the inner circumference, and are fixed to the outer circumference of the shaft portion 9b.

In the damping valve 1B assembled in this manner, the sub valve 3 is disposed at a position separated from the cup 32 by the spacer 33, and the outer circumference of the sub valve 3 faces the inner circumferential surface of the cylindrical portion 32b of the cup 32. The inner circumferential surface of the cylindrical portion 32b of the cup 32 functions as a facing portion that forms an annular gap P with the outer circumferential surface of the sub valve 3. Even when the sub valve 3 is stacked on the spacer 33, the height of the lower end of the sub valve 3 as viewed from the valve case 2 side is lower than the height of the lower end of the seat surface 2e1 of the valve seat 2e in FIG. 6, and the outer circumference of the sub valve 3 is allowed to be deflected in a direction away from the valve case 2 in the recess portion 2d.

As described above, in the damping valve 1B in the second modification, the valve case (valve seat member) 2 includes the bottomed cylindrical cup 32 accommodated in the recess portion 2d, the facing portion is formed by the cylindrical portion 32b of the cup 32, the spacer 5, 33 that is annular spacer and has a smaller diameter than the sub valve 3 is interposed between the sub valve 3 and the bottom portion 32a of the cup 32 and between the sub valve 3 and the leaf valve 4, respectively, and the guide rod (shaft member) 9 that holds the inner circumferences of the valve case (valve seat member) 2, the cup 32, the sub valve 3, the spacer 5, 33, and the leaf valve 4 is provided.

The damping valve 1B in the second modification configured as described above operates similarly to the damping valve 1, and generates a damping force by the sub valve 3 during the contraction operation of the shock absorber D at a very-low speed. According to the damping valve 1B in the second modification, since the valve case (valve seat member) 2 includes the cup 32 functioning as the valve seat of the sub valve 3 and includes the valve seat 2e of the leaf valve 4, similarly to the damping valve 1, the total length can be shortened, the number of parts can be reduced, and the assemblability can be improved. In addition, when the valve seat member main body B2, which is a portion other than the cup 32 of the valve case (valve seat member) 2, is manufactured by sintering, the cup 32 having high dimensional accuracy of the inner diameter of the cylindrical portion 32b may be accommodated in the recess portion 2d. Therefore, according to the damping valve 1B, it is easy to manage the dimension of the annular gap P between the sub valve 3 and the cylindrical portion 32b of the cup 32, and it is easy to realize the intended damping force characteristics. In addition, even if the valve case (valve seat member) 2 is configured by the valve seat member main body B2 and the cup 32, if the cup 32 is housed in the recess portion 2d and these are fixed by the guide rod (shaft member) 9, the valve case (valve seat member) 2 can be manufactured, so that the assemblability can be improved. The damping valves 1A and 1B may be applied to a piston portion of the shock absorber D.

Although the preferred embodiment of the present invention has been described in detail above, modifications, variations, and alterations can be made without departing from the scope of the claims.

### REFERENCE SIGNS LIST

1 Damping valve
2 Valve case (valve seat member)
2c Compression-side damping port (port)
2d Recess portion
2d1 Bottom portion
2d3 Outer wall
2e Valve seat
2e1 Seat surface
2e2 Inclined surface
2f Facing portion
3 Sub valve
4 Leaf valve
5, 33 Spacer
6 Valve stopper
9 Guide rod (shaft member)
10 Shock absorber main body
12 Rod
14 Outer shell
31 Ring
32 Cup
32b Cylindrical portion
B1, B2 Valve seat member main body
D Shock absorber
R Reservoir (operation chamber)
R2 Compression side chamber (operation chamber)

1. A damping valve comprising:
a valve seat member including an annular recess portion, a port that opens at a bottom portion of the recess portion, an annular valve seat that rises from an outer circumference of the recess portion, and a facing portion that is an annular shape and has an inner circumferential surface facing the recess portion;
a sub valve that is disposed in the recess portion to be separated from the bottom portion of the recess portion, is in the annular shape, forms an annular gap between an outer circumferential surface and the facing portion, and is allowed to be deflected in a direction separated from the valve seat member in the recess portion with an outer circumference side as a free end; and
a leaf valve that is in the annular shape, is disposed to be separated in an axial direction on a side of the sub valve opposite to the valve seat member, is allowed to be deflected with an outer circumference side as a free end, and is able to be separated and seated on the valve seat.

2. The damping valve according to claim 1,
wherein the valve seat member has an inclined surface between the facing portion and a seat surface on which the leaf valve of the valve seat is seated and separated.

3. The damping valve according to claim 1,
wherein the valve seat member includes a ring placed in an outer circumference outer wall forming the recess portion, and
the facing portion is formed on an inner circumferential surface of the ring.

4. The damping valve according to claim 1,
wherein the valve seat member includes a bottomed cylindrical cup accommodated in the recess portion,
the facing portion is formed of a cylindrical portion of the cup,
spacers are interposed between the sub valve and a bottom portion of the cup and between the sub valve and the leaf valve, the spacers being in the annular shape and having a smaller diameter than the sub valve, and
a shaft member that holds an inner circumference of the valve seat member, the cup, the sub valve, the spacer, and the leaf valve is included.

5. The damping valve according to claim 1, further comprising:
a valve stopper that is disposed between the sub valve and the leaf valve to be separated from the sub valve, is in the annular shape, allows to be deflected on the outer circumference side, and regulates deflection of the sub valve when the outer circumference of the sub valve is deflected in a direction away from the valve seat member and comes into contact with the valve case seat member.

6. A shock absorber comprising:
a shock absorber main body that has a cylindrical outer shell and a rod movably inserted into the outer shell and is extendable and contractible; and
a damping valve according to claim 1,
wherein the valve seat member partitions two operation chambers communicated with the shock absorber main body by the ports.

7. The damping valve according to claim 1,
wherein the annular gap provides resistance to a flow of liquid passing through the sub valve.

8. The damping valve according to claim 1, further comprising
an orifice formed between the valve seat and the leaf valve,
wherein a flow path area of the annular gap is smaller than a flow path area of the orifice.

9. The damping valve according to claim 1,
wherein the free end of the sub valve is allowed to be deflected in a direction toward and away from the valve seat member in the recess portion.
